(19) United States
(12) Patent Application Publication
(10) Pub. No.: US 2014/0127648 A1
(43) Pub. Date: May 8, 2014

(54) NUTRITIONAL GAME

(71) Applicant: Marie Green, Woodland Hills, CA (US)

(72) Inventor: Marie Green, Woodland Hills, CA (US)

(21) Appl. No.: 13/669,753

(22) Filed: Nov. 6, 2012

(51) Int. Cl. G09B 19/00

(52) U.S. Cl. CPC G09B 19/0092
USPC 434/127

(57) ABSTRACT

A game that encourages a player to eat nutritious food items that includes a game board having a plurality of contiguous spaces defining a playing path, wherein each space designates a given activity, and wherein one activity is designated to encourage the player to eat a nutritious food item; a playing piece for each player; chance means for determining the number of spaces a player can advance a playing piece along the playing path; and, means for encouraging the player to eat a nutritious food item based on the playing piece landing on a respective space on said playing path.

### CROSS-REFERENCE TO RELATED APPLICATION

This application is a Continuation Application of U.S. Non-Provisional Application Ser. No. 12/114,217 filed May 2, 2008 and claims the benefit of priority thereto.

### BACKGROUND

The present invention relates to games. More particularly, the present invention relates to a game that is used to encourage players to eat nutritious food items and thereby improve their health and eating habits by performing various tasks and by gaining knowledge related to good nutrition while playing the game.

### SUMMARY

As parents and the like are fully aware, having a child eat nutritious foods is an often a trying experience at best. Far too often children avoid eating fruits and vegetables during a given meal which leads to frustration for the adult and poor nutrition for the child. The present invention provides for a game that incorporates the eating of nutritious foods items which has the effect of getting a child to eat items it may not voluntarily eat. The game can be played at designated meal times such as breakfast, lunch, dinner, or any other time. As used herein, a “nutritious food item” includes any fruit, vegetable or otherwise healthful food item. And as used in the figures, the term FRUVEE is a fictional word that represents the combination of the words fruits and vegetables, and as such, is used to represent a nutritional food item as defined above.

In particular, this application discloses a game that encourages a player to eat nutritious food items at designated mealtimes such as at breakfast, lunch, snack, and dinner, comprising: a game board having a plurality of contiguous spaces defining a playing path, wherein each space designates a given activity, and wherein one activity is designated to encourage the player to eat a nutritious food item; a playing piece for each player; chance means for determining the number of spaces a player can advance a playing piece along the playing path; and, means for encouraging the player to eat a nutritious food item based on the playing piece landing on a respective space on said playing path.

This application also discloses a game that encourages a player to eat nutritious food items comprising: a game board having a plurality of contiguous spaces defining a playing path, wherein each space designates a given activity, and wherein one activity is designated to encourage the player to eat a nutritious food item; a playing piece for each player; chance means for determining the number of spaces a player can advance a playing piece along the playing path; and, an electronic device including a plurality of activity buttons, wherein an activity button is selected based on the playing piece landing on a respective space on said playing path, and wherein at least one activity button is a nutritious food item button that encourages the player to eat a nutritious food item.

Finally, this application discloses a game that encourages a player to eat nutritious food items comprising: a plurality of activities, wherein one activity is designated to encourage the player to eat a nutritious food item; means for determining which activity the player must do; and means for encouraging the player to eat a nutritious food item.

### BRIEF DESCRIPTION OF THE DRAWINGS

The drawings, when considered in connection with the following description, are presented for the purpose of facilitating an understanding of the subject matter sought to be protected.

FIG. 1 is a top plan view of the game board of the present invention;

FIG. 2 is a top plan view of the front and back of a first “Nutritious Food Item” activity card;

FIG. 3 is a top plan view of the front and back of a second “Nutritious Food Item” activity card;

FIG. 4 is a top plan view of the front and back of a “Ten Times” activity card;

FIG. 5 is a top plan view of the front and back of a “Question” activity card;

FIG. 6 is a top plan view of the front and back of a “Star” activity card;

FIG. 7 is a top plan view of the front and back of an “Everybody” activity card;

FIG. 8 is a perspective view of the game board in FIG. 1 showing game pieces, a die, a spinner, and activity cards;

FIG. 9 is a perspective view of second embodiment of the game board of the present invention showing a second embodiment of the game pieces;

FIG. 10 is a perspective top of an electronic device usable with the present invention;

FIG. 11 is a perspective view from another angle of a first embodiment of the electronic device in FIG. 10;

FIG. 12 is a perspective view from another angel of a second embodiment of the electronic device in FIG. 10;

FIG. 13 is a perspective view of a spinning container usable with the present invention; and,

FIG. 14 is a perspective view of the spinning container in FIG. 13 showing a segment lid open and a nutritious food item contained therein.

### DETAILED DESCRIPTION

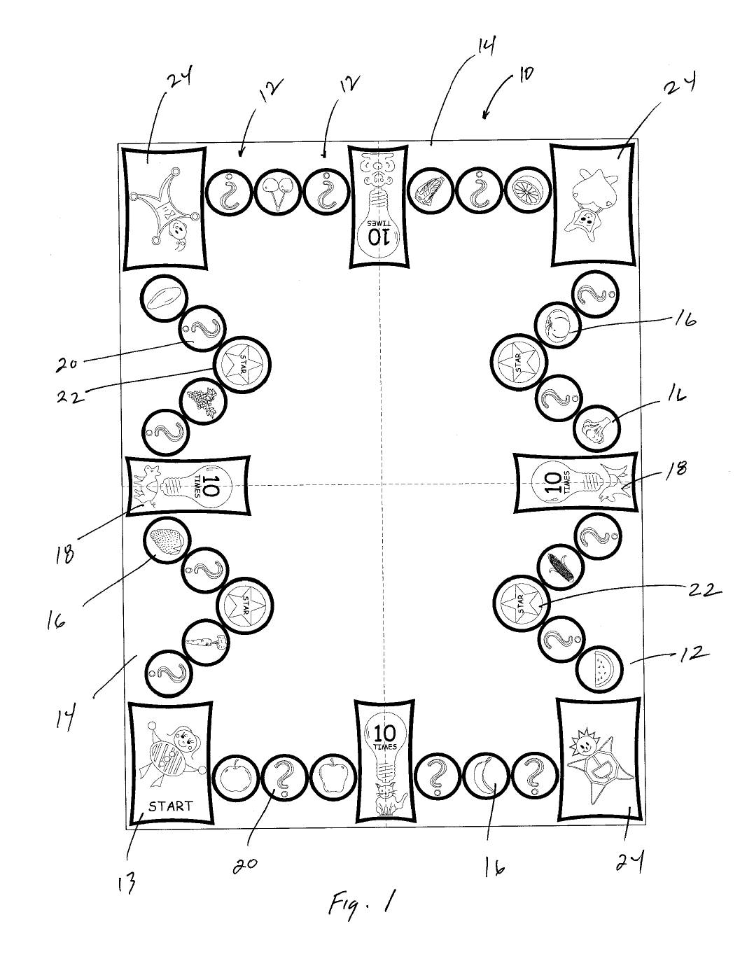

As shown in FIG. 1, the game board 10 usable in the present invention includes a plurality of contiguous spaces 12 (including a starting space 13), printed on the upper surface of the game board 10 defining a playing path 14 in a generally circular pattern. The game board 10 spaces 12 each represent a specific activity such as “Nutritious Food Item” spaces 16, “Ten Times” spaces 18, “Question” spaces 20, “Star” spaces 22, and “Everybody” spaces 24. In the preferred embodiment, the type of space can be indicated by different characters as shown, however, the spaces 12 could be of different colors with each color representing a given activity space.

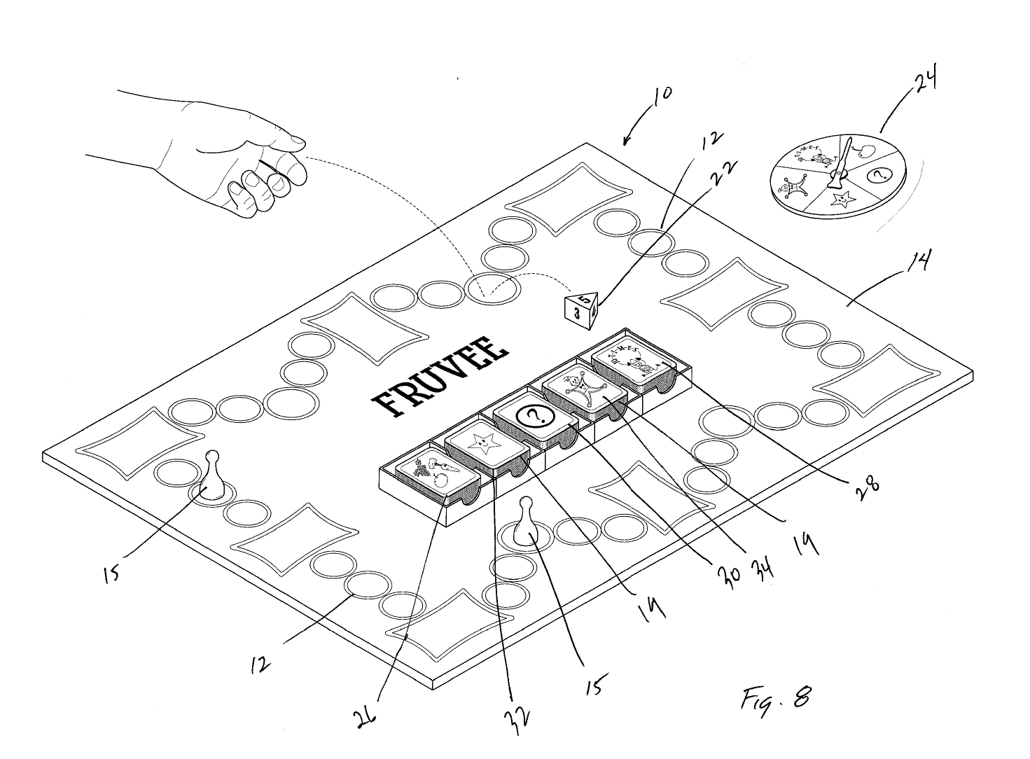

Referring now to FIG. 8, shown therein is a first embodiment of the nutritional game to encourage players to eat nutritious food items at designated mealtimes such as at breakfast, lunch, snack, and dinner. The game includes the game board 10 having a plurality of contiguous spaces 12 defining a playing path 14, a playing piece 15 for each player, chance means for determining the number of spaces a player can advance a playing piece along the playing path, and a plurality of activity cards 19 optionally contained in a segmented holder 20. As shown, the chance means may include a die 22, spinner 24 or any other similar device. The die 22 or spinner 24 can include numbers or pictures of the spaces to assist younger players that are unable to count.

The spaces 12 each correspond to a respective plurality of activity cards 19 such that there are “Nutritious Food Item” activity cards 26, “Ten Times” activity cards 28, “Question” activity cards 30, “Star” activity cards 32, and “Everybody” activity cards 34.

At the start of the game players role a die 22 or spin a spinner 24 to determine the order said players play the game, or the players can allow the youngest player to go first. The players' turns are determined by having the player obtaining the highest number on the role or spin to take their turn first. The remaining players take there turns starting in a clockwise direction from the player having the highest roll or spin or the youngest player. A player's advances along the playing path 12 is determined by the throw of the die 22 or the spinner 24, with the number of the die 22 or spinner 24 being the number of spaces a player moves their playing piece 15 along the playing path 14. Alternatively, the die 22 and spinner 24 will substitute pictures of the spaces instead of numbers to assist younger players that are unable to count.

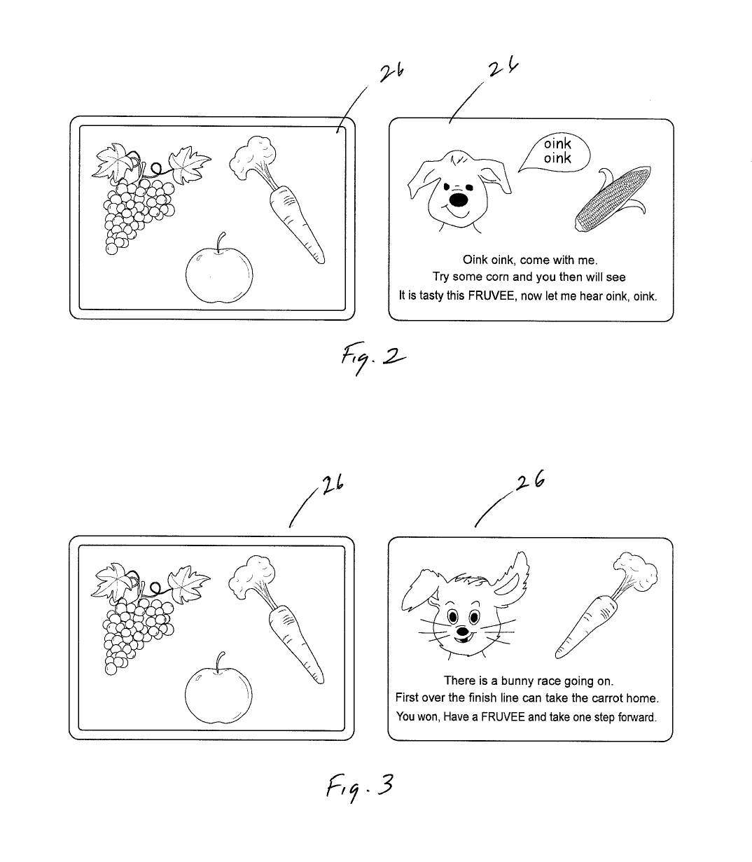

If a player advances his/her playing piece 15 to a nutritious food item space 16, the player must select a nutritious food item activity card 26 from the top of a deck of the nutritious food item activity cards 26. The nutritious food item activity cards 26 are used to encourage the player to eat a nutritious food item. If the player does in fact eat the nutritious food item, he or she is rewarded in a variety of potential ways. FIG. 2 is an example of the front and back of a nutritious food item activity card 26. As shown in FIG. 2, the reward is that the player is allowed to engage in the endeavor of making an animal sound. Alternative endeavors may include, but are not limited to singing, dancing, and any other endeavor that the player would find enjoyable. An alternative reward is shown in FIG. 3. In this instance the player is rewarded with the opportunity to move one step or space forward, thereby making more progress on the playing path 14. Further, if the player does advance to the next space 12 or any other number of spaces 12, the player may select another activity card 19 for the respective space 16 landed upon. A further reward is that a player would receive another turn if the nutritious food item is eaten by the player, wherein a turn is another opportunity to doll the die 22 or spin the spinner 24 and advance the player's playing piece 15 forward on the playing path 14.

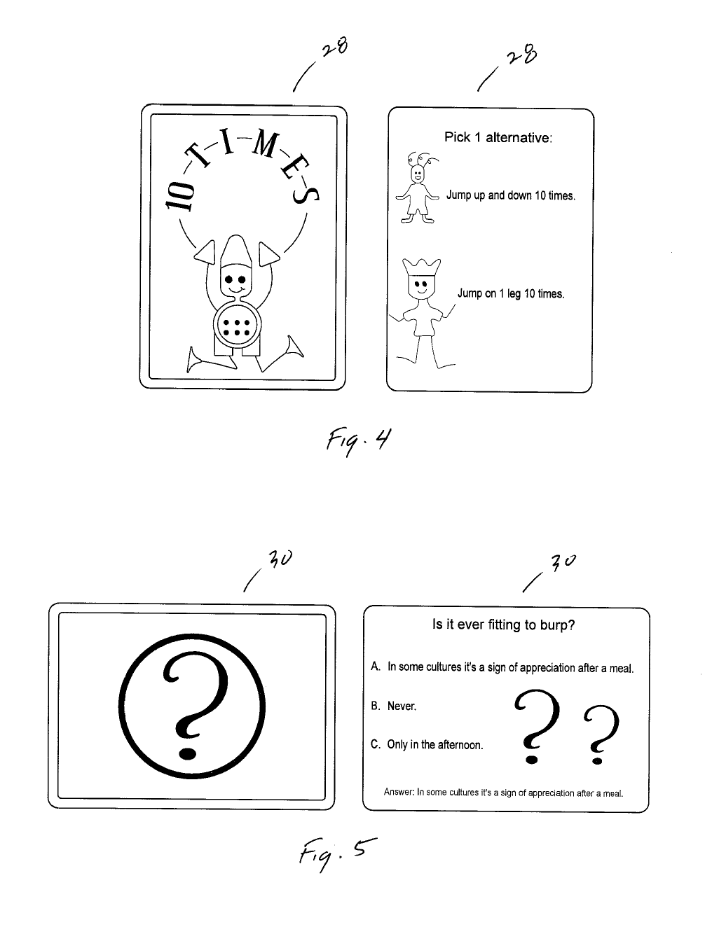

If a player advances his/her playing piece 15 to a ten times space 18, the player must select a ten times activity card 28 from the top of a deck of the ten times activity cards 28. The ten times activity cards 28 are used to encourage the player to exercise. FIG. 4 is an example of the front and back of a ten times activity card 28.

If a player advances his/her playing piece 15 to a question space 20, the player must select a question activity card 30 from the top of a deck of the question activity cards 30. The question activity cards 30 are used to provide knowledge on a variety of subjects including customs and nutritional facts, which provide the player knowledge about nutrition. FIG. 5 is an example of the front and back of a question activity card 30.

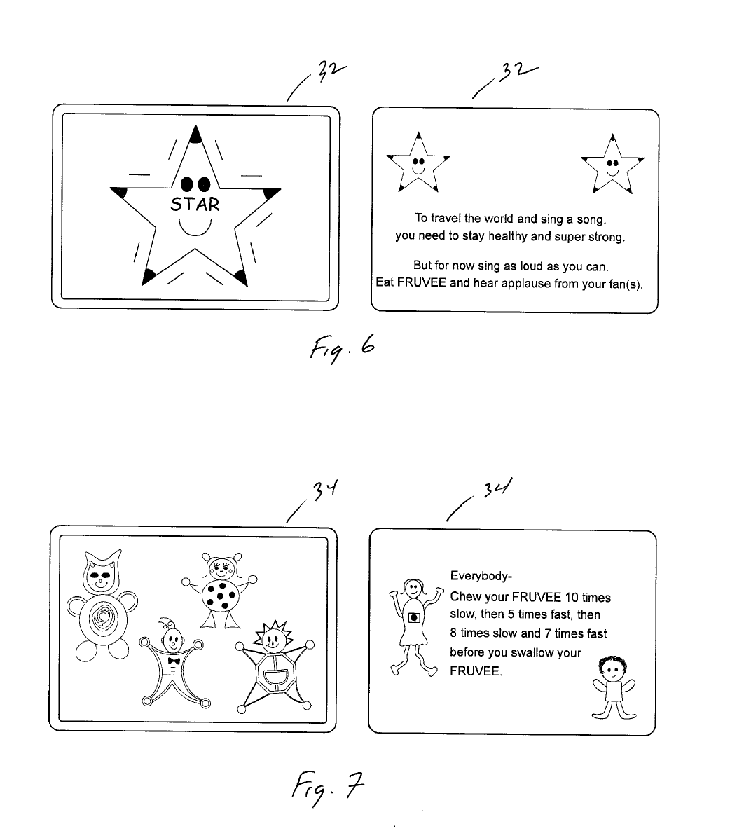

If a player advances his/her playing piece 15 to a star space 22, the player must select a star activity card 32 from the top of a deck of the star activity cards 32. The star activity cards 32 are used to help provide self esteem in the player as the fellow players are asked to clap and cheer for the player in response to some activity performed by the player such as being asked to sing, flex muscles, dance, smile, or any other similar activity. FIG. 6 is an example of the front and back of a star activity card 32.

Finally, if a player advances his/her playing piece 15 to an everybody space 24, the player must select an everybody activity card 34 from the top of a deck of the everybody activity cards 34. The everybody activity cards 34 are used to provide activities for all the players in the game such as eating a nutritious food item together. FIG. 7 is an example of the front and back of an everybody activity card 34.

The winner of the game is the player that either circles the playing path 14 first or the player that eats the most nutritional food items. For example, a token (not shown) can be provided for each nutritional food item eaten by a player and the one with the most tokens at the end of the game or the one that reaches a predetermined goal first, wins.

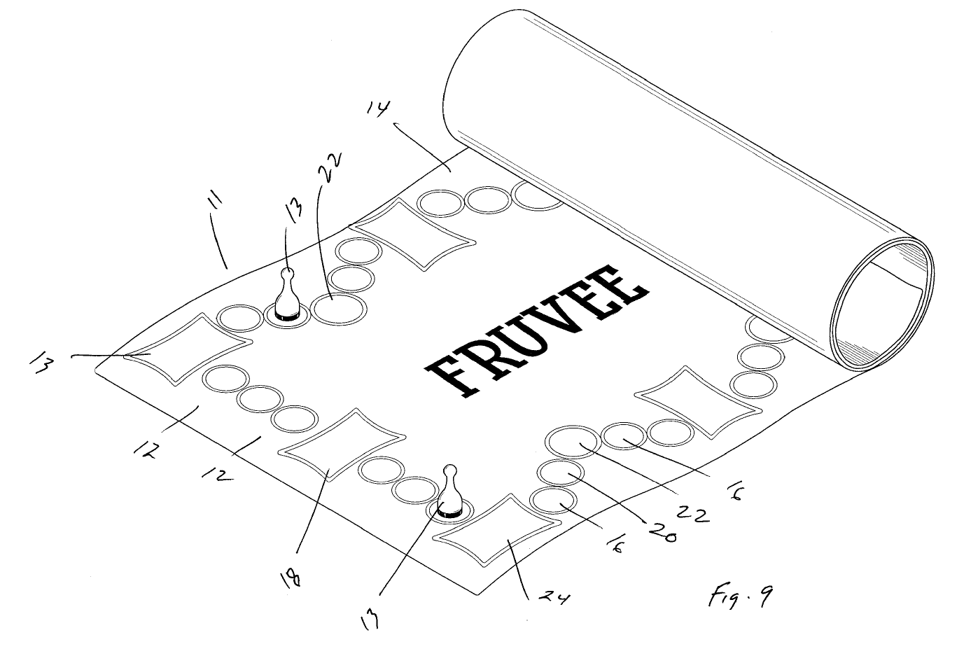

In FIG. 9, an alternative embodiment of the game board 10 and playing pieces 14 are shown. In this embodiment a magnetized board 11 can be used in connection with magnetized playing pieces 13. Preferably the magnetized game board 11 is sufficiently flexible such that it can be rolled up for easy transport. Such an embodiment would be useful for playing the game on the road or while traveling on vacation.

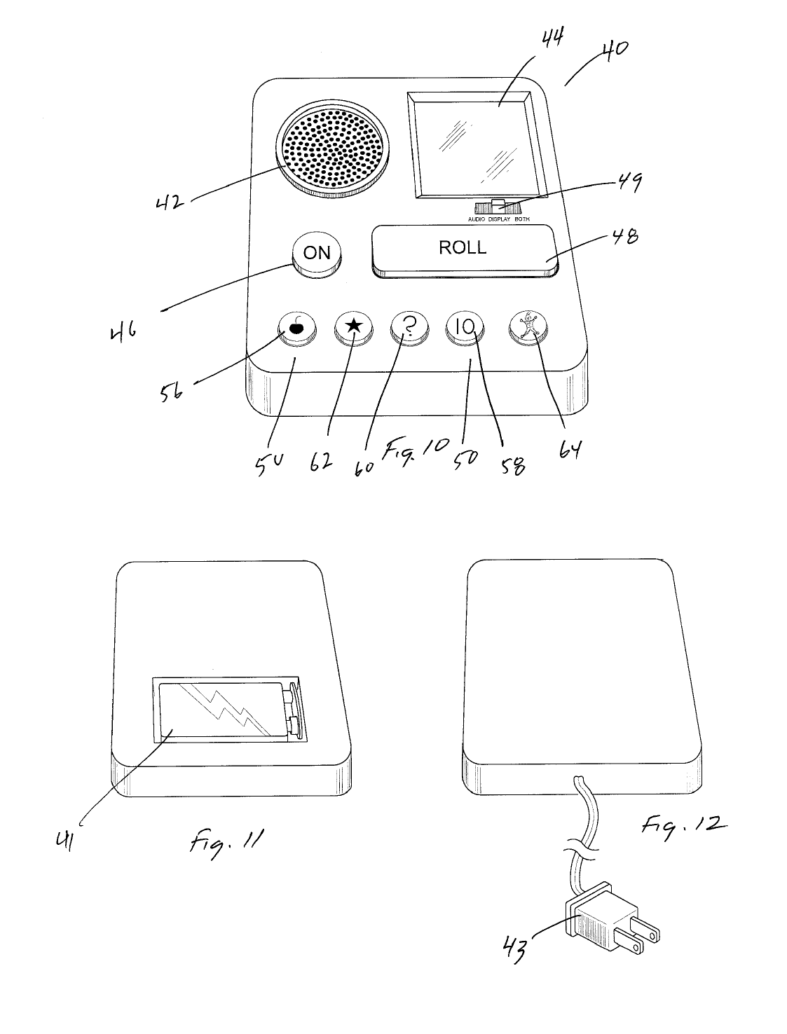

In a further embodiment, referring now to FIGS. 10-12, an electronic device 40 is shown that may be used in conjunction with the board game described above so as to either supplement or take the place of the activity cards 19. The electronic device includes an audio emitting device such as a speaker 42, a display 44, a power button 46, a chance means such as roll button 48, and a switch 49 to choose between audio only, the display only, or both at the same time. The device 40 may be powered by a standard or rechargeable battery 41 and/or include a plug 43 for insertion into a standard outlet (not shown).

The electronic device also includes a plurality of activity buttons 50, wherein an activity button 50 is selected based on a playing piece 15 (or magnetized playing piece 13 and magnetized game board 11) landing on a respective space 12 on the playing path 14. As with the activity cards 19 described above, the spaces 12 each correspond to a respective activity button 50 such that there is a “Nutritious Food Item” activity button 56, a “Ten Times” activity button 58, a “Question” activity button 60, a “Star” activity button 62, and an “Everybody” activity button 64.

When utilizing the device 40 in the game described above, the player would press the roll button 48 to determine what space 12 to advance his or her playing piece 15 to on the playing path 14. The number or character would be displayed on the display 44 and/or announced through the speaker 42. The player would depress the nutritious food item activity button 56, which would have the content of the nutritious food item activity cards 26 stored in memory and thereby provide the encouragement for the player to eat a nutritious food item and be rewarded as previously described for the nutritious food item activity cards 26. The other activity buttons 58, 60, 62, 64 would provide the same function as the respective activity cards 19 described above.

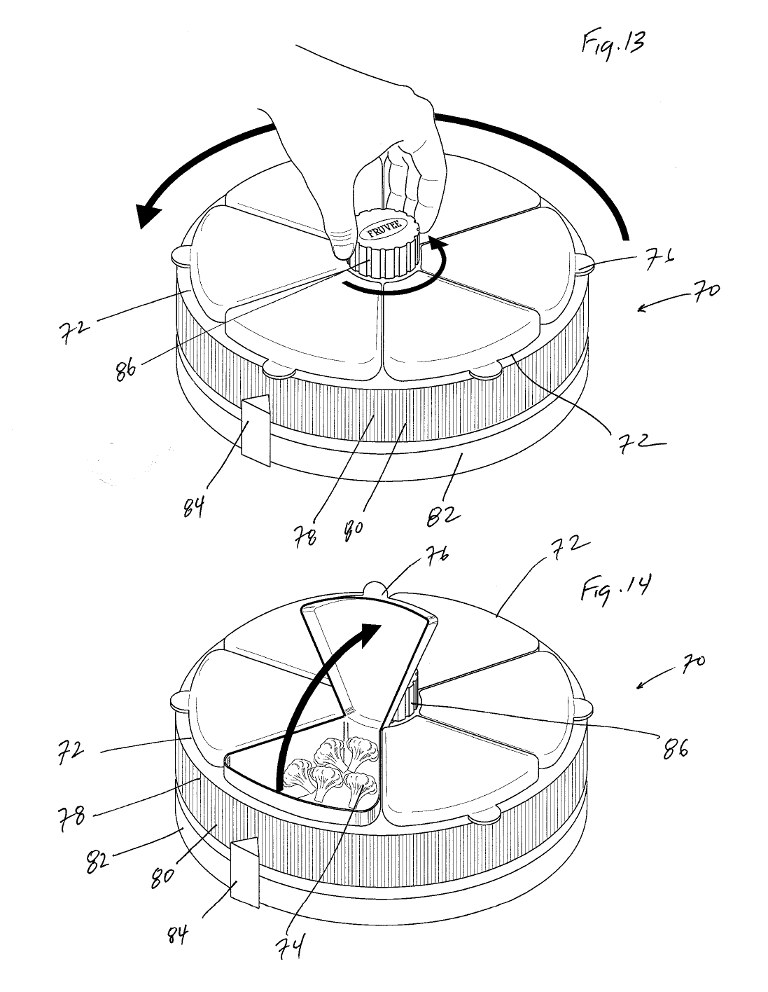

In yet a further embodiment, referring now to FIGS. 13 and 14, an additional means for encouraging the player to eat a nutritious food item is shown. As shown, a spinning container 70 may be used in conjunction with the board game described above. The spinning container 70 includes a plurality of segments 72 so dimensioned to contain nutritious food items 74 therein, liftable hinged tops 76 to conceal the food items 74 when shut and provide access to the food items when open. The container further includes a rotating handle 86 that a user engages to drive a rotating portion 78, which is rotateably mounted on a stationary portion 82. The rotating portion 78 includes ridges 80 on its surface and the stationary portion 82 includes a feeler/indicator 84 to partially engage the ridges 80 so as to slow down the rotating portion 78 and indicate what segment 72 is to be opened and thereby what nutritious food item is to be removed and eaten by the player. During play, if a nutritious food item space 16 in landed upon and the player must eat a nutritious food item 74 to advance, the spinning container 74 can be utilized to enhance the encouragement of the player to eat the item 74 by adding the random nature of the spinning container 70.

In an alternative embodiment, the game board 10 is not required for playing the game. In this embodiment the same activities described in the board game above are utilized and placed on the plurality of activity cards 19. Again the respective plurality of activity cards 19 include the “Nutritious Food Item” activity cards 26, “Ten Times” activity cards 28, “Question” activity cards 30, “Star” activity cards 32, and “Everybody” activity cards 34. The method of determining which activity the player must do can be determined in a number of ways, such as but not limited to, turning over an activity card in a random manner, passing cards out to the player or players, and utilizing a die 22 or spinner 24 to determine which activity card 19 should be selected. The winner of this game would be the player that eats the most nutritious food items. In addition, various rewards would be provided to the player as encouragement to eat the nutritious food items including, but not limited to, winning the game as mentioned above, the player receiving another turn as a reward if the nutritious food item is eaten by the player, and allowing the player to use the spinning container 70 to designate what nutritious food items the player is to eat.

A further embodiment of the game can be played without the game board 10. In this embodiment, referring again to FIGS. 10-12, the electronic device 40 is utilized. Again, a plurality of activity buttons 50 each representing an activity described above is utilized, namely, a “Nutritious Food Item” activity button 56, a “Ten Times” activity button 58, a “Question” activity button 60, a “Star” activity button 62, and an “Everybody” activity button 64.

When utilizing the device 40 in the boardless game, the player would press the roll button 48 to determine what activity button 50 to select. The character would be displayed on the display 44 and/or announced through the speaker 42. The player would depress the designated activity button 50, for example the nutritious food item activity button 56, which would have the content of the nutritious food item activity card 26 stored in memory and thereby provide the encouragement for the player to eat a nutritious food item and be rewarded as previously described for boardless game described above. The rest of the activity buttons 50 would likewise be included representing the other activity cards 19. Again, the winner of this game would be the player that eats the most nutritious food items.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A game that encourages a player to eat nutritious food items at designated meal times such as breakfast, lunch, snack, and dinner, comprising:
a game board having a plurality of contiguous spaces defining a playing path, wherein each space designates a given activity, and wherein at least one activity is designated to encourage the player to eat a nutritious food item at designated meal times such as breakfast, lunch, and dinner;
a playing piece for each player;
chance means for determining how many of the contiguous spaces a player can advance a playing piece along the playing path; and,
means for encouraging the player to eat a nutritious food item based on the playing piece landing on a respective space on said playing path, wherein the means for encouraging the player to eat a nutritious food item includes a plurality of activity cards, wherein an activity card is selected based on the playing piece landing on a respective space on said playing path, and wherein at least one activity card is a nutritious food item card that encourages the player to eat a nutritious food item, wherein the encouragement provided by said nutritious item card includes the player's playing piece advancing ahead at least one space on the playing path as a reward if the nutritious food item is eaten by the player.

2. The game of claim 1, wherein when the player's playing piece advances at least one space ahead as a reward for the player eating the nutritious food item, the player selects another activity card for the respective space landed upon.

3. The game of claim 1, wherein the encouragement provided by said nutritious item card includes the player engaging in an endeavor as a reward if the nutritious food item is eaten by the player.

4. The game of claim 1, wherein the encouragement provided by said nutritious item card includes the player receiving another turn including another action using the chance means as a reward if the nutritious food item is eaten by the player.

5. The game of claim 1, wherein the means for encouraging the player to eat a nutritious food item includes a means for selecting which nutritious food item the player is to eat.

6. The game of claim 5, wherein the means for selecting which nutritious food item the player is to eat is a spinning container, wherein the container includes a plurality of segments to contain nutritious food items therein, and wherein the means for selecting which nutritious food item the player is to eat comprises a spinner which is capable of spinning and stopping at a random location, thereby designating what nutritious food items the player is to eat.

7. A game that encourages a player to eat nutritious food items comprising:
a game board having a plurality of contiguous spaces defining a playing path, wherein each space designates a given activity, and wherein at least one activity is designated to encourage the player to eat a nutritious food item;
a playing piece for each player;
chance means for determining how many of the contiguous spaces a player can advance a playing piece along the playing path; and,
an electronic device including a plurality of activity buttons, wherein an activity button is selected based on the playing piece landing on a respective space on said playing path, and wherein at least one activity button is a nutritious food item button that encourages the player to eat a nutritious food item.

8. The game of claim 7, wherein the encouragement provided by said nutritious item button includes the player's playing piece advancing ahead at least one space on the playing path as a reward if the nutritious food item is eaten by the player.

9. The game of claim 8, wherein when the player's playing piece advances at least one space ahead as a reward for the player eating the nutritious food item, the player selects another activity button for the respective space landed upon.

10. The game of claim 7, wherein the encouragement provided by said nutritious item button includes the player engaging in an endeavor as a reward if the nutritious food item is eaten by the player.

11. The game of claim 7, wherein the encouragement provided by said nutritious item button includes the player receiving another turn as a reward if the nutritious food item is eaten by the player.

12. A game that encourages a player to eat nutritious food items comprising:
a plurality of activities, wherein one activity is designated to encourage the player to eat a nutritious food item;
means for determining which activity the player must do; and
means for encouraging the player to eat a nutritious food item.

13. The game of claim 12, wherein the means for encouraging the player to eat a nutritious food item includes a plurality of activity cards, and wherein the means for determining which activity the player must do is determined by randomly turning over said activity card, and wherein at least one activity card is a nutritious food item card that encourages the player to eat a nutritious food item.

14. The game of claim 12, wherein the encouragement provided by said nutritious item card includes the player engaging in an endeavor as a reward if the nutritious food item is eaten by the player.

15. The game of claim 12, wherein the encouragement provided by said nutritious item card includes the player receiving another turn as a reward if the nutritious food item is eaten by the player.

16. The game of claim 12, wherein the means for encouraging the player to eat a nutritious food item includes a means for selecting which nutritious food item the player is to eat, and wherein the means for selecting which nutritious food item the player is to eat is a spinning container, wherein the container includes a plurality of segments to contain nutritious food items therein, and wherein the spinner is capable of spinning and stopping at a random location, thereby designating what nutritious food items the player is to eat.

17. The game of claim 12, wherein the means for encouraging the player to eat a nutritious food item includes an electronic device including a plurality of activity buttons, wherein the means for determining which activity the player must do is determined by which activity button is selected, and wherein at least one activity button is a nutritious food item button that encourages the player to eat a nutritious food item.

18. The game of claim 17, wherein the encouragement provided by said nutritious item button includes the player engaging in an endeavor as a reward if the nutritious food item is eaten by the player.
